(19) United States
(12) Patent Application Publication
(10) Pub. No.: US 2023/0303433 A1
(43) Pub. Date: Sep. 28, 2023

(54) METHOD OF ATTACHING A CONNECTOR TO A GLAZING

(71) Applicant: CARLEX GLASS AMERICA, LLC, Nashville, TN (US)

(72) Inventors: Jacob Daniel RIGELMAN, Garrett, IN (US); Emily Anne CURTIS, Nashville, TN (US)

(21) Appl. No.: 18/019,427

(22) PCT Filed: Aug. 6, 2021
(86) PCT No.: PCT/US2021/044889

§ 371 Date: Feb. 2, 2023

Related U.S. Application Data
(60) Provisional application No. 63/062,042, filed on Aug. 6, 2020.

(51) Int. Cl. C03C 17/36; B23K 35/30; B23K 1/19; B23K 1/00; B23K 3/06; C03C 17/40

(52) U.S. Cl. CPC C03C 17/3673; B23K 35/3006; B23K 1/19; B23K 1/0016; B23K 3/0638; C03C 17/40; B23K 2101/36

(57) ABSTRACT

A method of attaching an electrical connector to a glass substrate, includes the steps of positioning a connector over a glass substrate in an area for attaching the connector, and extruding a soldering material over the connector. Where the glazing includes a busbar on the glass substrate, the busbar may be arranged in the area for attaching the connector.

### CROSS REFERENCE TO RELATED APPLICATION

This application claims priority to U.S. Provisional Application No. 63/062,042 filed on Aug. 6, 2020, entitled “CONNECTION OF AN ELECTRICAL CONNECTOR”, the entire contents of which are incorporated by reference herein in their entirety.

### TECHNICAL FIELD

The present disclosure generally relates to a method of attaching an electrical connector to a glazing.

### BACKGROUND

Glazings are used for automobiles and building materials, and particularly, glazings for automobiles may include one or more glass substrates and wire connectors connected to a connectable material. Such a wire connector is used for proving an electrical current via the conductive materials to operate certain devices or activate heating for wipers. In a conventional method for coupling the wire connector with the conductive materials, an operator manually handles a soldering iron to adhere the wire connector to the conductive materials with solder. Electrical connectors traditionally have been soldered to electrically conductive materials in automotive glass via solder alloy having lead. However, new directives have instituted use of lead-free solders, which have proven difficult, as mechanical stresses at the connectors lead to cracks in an underlying glass.

### SUMMARY OF THE DISCLOSURE

It is therefore an object of this disclosure to provide a method of attaching an electrical connector to a glass substrate with reduced stresses to the glass substrate underlying the connector.

Disclosed herein is a method of attaching a connector to a glass substrate, comprising the steps of: positioning a connector over a glass substrate at a connecting surface for attaching the connector and extruding a soldering material over the connector.

According to some embodiments of the disclosure, the connecting surface may include any of silver, copper, and nickel. The glass substrate may be part of a laminated or tempered glazing. The soldering material may comprise at least one of indium, tin, silver, and alloys thereof, and particularly, may comprise either an indium based solder alloy or a tin-silver based solder alloy. In some embodiments of the disclosure, the connector may include any of a wire, a mesh, and a foil.

According to some embodiments of the disclosure, the step of extruding the soldering material includes a step of extruding the soldering material in a pattern. The pattern may include more than one layer. Alternatively, the step of extruding the soldering material may include extruding the soldering material with no pattern. The glazing may be heated when the soldering material is extruded. In some embodiments, the soldering material may be extruded from an extruder with a nozzle having a diameter of 0.5 mm or more. The connector may be adhered with an adhesive while the connector is positioned over the glazing. In some embodiments, the glass substrate may be heated during solder extrusion. Flux may be applied to the connecting surface and/or the connector prior to extrusion of the soldering material.

In another aspect of this disclosure, a soldered connector structure may include a glass substrate, a connecting surface formed on the glass substrate, a soldering material formed by extrusion on the connecting surface, and a connector electrically coupled to the connecting surface via the soldering material.

According to some embodiments of the disclosure, indium based solder or tin-silver based solder may form the soldering materials. The connector may include any of a wire, a mesh, and a foil.

### BRIEF DESCRIPTION OF THE DRAWINGS

The accompanying drawings, which are incorporated into and constitute a part of this specification, illustrate one or more aspects of the present disclosure and, together with the detailed description, serve to explain their principles and implementations.

FIG. 1 illustrates a process of positioning a connector on a connecting surface, according to a method of the present disclosure;

FIG. 2 illustrates a stage of an extruding process, according a method of the present disclosure;

FIG. 3 illustrates a finishing stage of the extruding process, according to a method of the present disclosure;

FIG. 4 is a plan view showing a soldered connector structure using a mesh connector, according to aspects of the present disclosure;

FIG. 5 is a cross section showing the soldered connector structure illustrated in FIG. 4;

FIG. 6 is a plan view showing a soldered connector structure using a foil connector, according to aspects of the present disclosure;

FIG. 7 is a plan view showing a soldered connector structure using a foil connector, according to aspects of the present disclosure;

FIG. 8 is a plan view showing a soldered connector structure using another foil connector, according to aspects of the present disclosure; and

FIG. 9 is a cross section showing the soldered connector structure of FIG. 6 along A-A′.

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below. This disclosure relates generally to a method of attaching an electrical connector to a glass substrate.

Glazings, including automotive glazings, may have electrical connectors where power is to be supplied to the glazing or an element of the glazing. Particularly, a coating or print may be powered, for example, to be heated. Printed silver, for example, may be located across a glazing, such as heating lines across a rear window, or in a localized area, such as for wiper park heating. Coatings or printings may require a connector to provide power from an electrical source to heat the coating or print. Antennas may also require a connector for connecting to a signal receiver. In some glazings, a connectable material may be provided on a glazing interior surface and connected prior to lamination. Some further glazings having an electrical connection may be non-laminated glazings. Among other things, a method of attaching a connector, as disclosed herein, may advantageously work for both glass substrates that are laminated or not laminated, including tempered glazings.

A glass substrate for attaching a connector may be part of a laminated glazing which may include more than one glass substrate. A laminated glazing may include a first glass substrate and a second glass substrate laminated together with an interlayer material therebetween. The thickness of the glass substrates is not particularly limited, but is preferably from 0.5 mm to 3 mm, more preferably from 1 mm to 2.5 mm. The glass substrates may include, without limitation, soda-lime silicate glass described by ISO 16293-1:2008. In some embodiments, the first glass substrate may be an exterior glass substrate facing a vehicle exterior when the glazing is installed, and the second substrate may be an interior glass substrate facing a vehicle interior when the glazing is installed. An interlayer may be a polymer adhesive, such as polyvinyl butyral (PVB) or ethylene vinyl acetate (EVA) or an ionomer.

Generally tempered glass has glass strength, impact resistance, elasticity, etc., and includes heat tempered glass using heat treatment and chemically tempered glass using chemical ion exchange. Tempered glass may have a surface compressive stress of 50 MPa or more, preferably 100 MPa or more, and more preferably 200 MPa or more.

A glazing may include a coating or print of material which may be electrically connectable on a glass substrate. Coatings may, for example, include metals or conductive oxides. In some embodiments, the electrically connectable materials may be printed onto the glazing, including by screen printing. For example, silver, or silver alloy, material may be screen-printed onto a glass window. Printed electrically connectable materials may further be provided in an area of a windshield or rear window where a wiper may sit in an off position. Such a “wiper park” may include a printed silver which is heatable by connection to a power supply. A printed connectable material may be any suitable pattern to provide adequate heating or power to a desired area or areas and may include an area printed for connecting to an electrical connector. In some embodiments, the glazing may include an opaque print at a periphery and/or around an accessory, such as a camera or sensor, and the silver may be printed on the glass and/or an opaque print. The connectable print may include an area which is to be connected to a connector.

Connectors may be traditionally attached to a glazing using soldering techniques. Such traditional soldering techniques may include heating soldering material between a connector and a glazing. The soldering material may melt and form an attachment to the glazing and connector upon re-solidifying. Changes in temperature and material composition may lead to cracks being formed in glass during this process. It is desirable to provide a soldering process which will maintain the underlying glass. As described below, the connectors may be constructed in any suitable form such as, e.g., wire, ribbon, foil, mesh, or a bar, which will be attached to the busbar or any other terminals by the soldering material. Where a wire connector has a frayed end, there are advantages for electrical connection between the wire connector and the busbar. The frayed end may provide a larger surface area for contact at the end of the connector compared to a non-frayed end, and may bring, at the attachment, electrically lower resistance, improved mechanical attachment, and further efficient dissipation of heat stresses generated by the metal of the wire connector. Some connectors may include multiple attachment points, which may include, for example multiple wire, foil, or mesh ends connected to a connecting surface which may connect to a single power source. In some embodiments the multiple connector ends may connect to each other to provide one connection point for a power source. Such a construction may spread out the connections over a connecting surface to prevent a hot spot forming at the connector.

According to the present disclosure, a soldering material may be applied to a glazing using a metal extrusion process, which may provide a vertical soldering system. The vertical application of the soldering material may be more controlled than traditional methods. Metal extrusion may allow for an automated distribution of metal solder alloy without a carrier or terminal. The soldering materials may include indium, tin, silver, and alloys including such metals. The soldering materials may include any of an indium based solder alloy or a tin-silver based solder alloy. An indium-based solder alloys are known to have a longer fatigue life, better mechanical properties, and reliability. An indium-based solder alloy may be composed of an alloy containing such as, e.g., indium of 5 to 95% by mass, tin of 5 to 95% by mass, silver of 0 to 10% by mass, antimony of 0 to 10% by mass, copper of 0 to 10% by mass, zinc of 0 to 10% by mass, and nickel of 0 to 10% by mass, with respect to the total mass of the lead-free solder alloy. As a more preferable example of the indium-containing lead-free solder alloy, a solder alloy is exemplified as containing indium of 65 to 95% by mass, tin of 5 to 35% by mass, silver of 0 to 10% by mass, antimony of 0 to 3% by mass, copper of 0 to 5% by mass, zinc of 0 to 5% by mass and nickel of 0 to 5% by mass, with respect to the total mass of the lead-free solder alloy. A tin-silver-based lead-free solder alloy or tin-silver-copper-based lead-free solder alloy may also be used as the soldering material. The tin content in the tin-silver-based lead-free solder alloy or the tin-silver-copper-based lead-free solder alloy may be 95% by mass or more, preferably 95 to 99% by mass, with respect to the total mass of the lead-free solder. A tin content of 96 to 98% by mass is particularly preferable. The silver content in the tin-silver-based lead-free solder alloy or the tin-silver-copper-based lead-free solder alloy is preferably 5% by mass or less, more preferably 1.5 to 5% by mass, with respect to the total mass of the lead-free solder. The silver content of 2 to 4% by mass is particularly preferable. The copper content of the tin-silver-copper-based lead-free solder alloy is preferably 5% by mass or less, more preferably 0.1 to 2% by mass, and even more preferably 0.2 to 1% by mass, with respect to the total mass of the lead-free solder.

The soldering materials may include those used in traditional soldering techniques. Preferably, the soldering materials may have a melting point equal to or below 500° C. The soldering materials may preferably have a melting temperature of at least 175° C. Where a connector is attached to a connecting surface, such as a busbar, on a glass substrate, the soldering material may have a coefficient of thermal expansion similar to or the same as the glass substrate. The soldering material may be extruded over a connector and form a bond on a glazing connecting surface, which may include a busbar. The busbar may be formed by any suitable means, including screen printing, and may contain any of silver, copper, and nickel. The busbar may be a silver-containing material and/or a metallic tape, such as a copper tape. A copper tape may be positioned over connectable materials and form a suitable surface for attaching a connector. A busbar may be formed to connect a coating, a printed silver layer, an antenna, or any other suitable material to a connector.

Metal extrusion may include melting the soldering material and administering the soldering material from a location above the glazing connecting surface. The soldering material may be at a temperature such that it does not solidify prior to reaching the glazing. An extruder of the soldering material may include a capillary or nozzle to supply the melted soldering material to a targeted area on a workpiece. In some embodiments, a vertical soldering material extruder is employed to vertically provide the melted soldering material over the connector. Such a soldering material extruder can be controlled manually or automatically in a manner provided on a tip of a robot arm on a manufacturing line. The diameter of the nozzle of the vertical soldering material extruder may be in range of 0.5 mm to 10 mm, preferably 1.0 mm to 8.0 mm, and more preferably 2.0 mm to 5.0 mm. The diameter of the nozzle may be selected based on a desired application of soldering material, including the size of a shape or pattern of soldering material. The soldering material may be provided in a filament or rod having a diameter larger than the diameter of the nozzle. The difference may cause pressure at the nozzle which may improve dispersal of the soldering material.

With such a soldering material extrusion, the soldering material may be adequately provided over the connector. When the soldering material becomes solid, the soldering material may form a shape of such as, e.g., a mound or a disc or rectangle. Such a shape may be formed from a drop of solder material or a pattern of solder material. Where the soldering material is formed in a mound shape, the soldering material may have a diameter in a range of 1 mm to 20 mm, preferably 5 mm to 15 mm, and a height in a range of 0.5 mm to 5 mm, preferably 1 mm to 3 mm. The soldering material may be extruded at one or multiple spots or may be in a manner of drawing lines or other shapes. In accordance with the form and shape of the connector or busbar, the soldering material may be provided in a manner to draw a pattern as described specifically below. Alternatively, the soldering material may be extruded without any pattern.

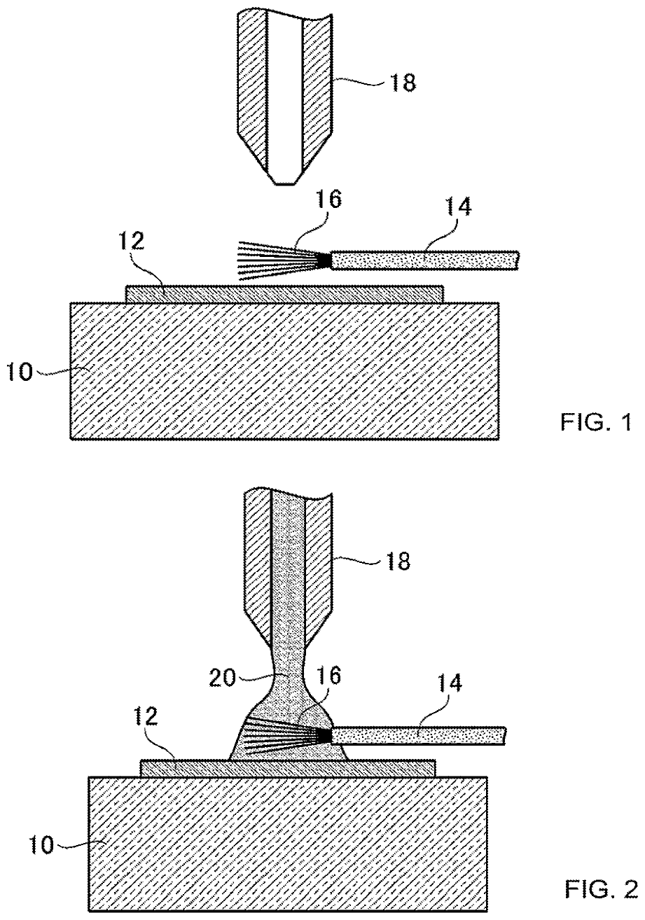

A connecting surface may be burnished and may have flux applied thereto prior to extrusion of the soldering material. The flux may also be applied to the connector, including a wire end, foil, or mesh. In some embodiments, the connector may include a wire end which is positioned over a connecting surface. As shown in FIG. 1, a wire connector 14 as the electrical connector may include multiple wire threads and the wire end 16 may include a portion of the wire 14 having the threads spread apart from each other, or a frayed end. The wire connector 14 may be provided over the connecting surface 12 on a glass substrate 10 from a wire reel in some embodiments. The glass substrate 10 may be part of a laminated glazing or may be a tempered glass sheet.

The wire may be made of copper, aluminum, nickel, silver or any other suitable metals or alloys. A wire may also be coated with a suitable plating material(s), such as silver, nickel, or tin, which may improve bonding to the solder alloy. The wire connector may include a metal wire portion, which may include a braided wire or a single wire, with a diameter in a range from 0.1 mm to 10 mm, preferably a range from 0.5 mm to 5 mm. Where the wire connector is a single wire, it may preferably have a diameter of 0.1 mm to 5 mm, more preferably 0.5 mm to 2 mm. Wire connector 14 may preferably include a portion at the wire end 16 that includes an exposed metal surface and a portion not at the wire end 16 having insulation material over the metal material.

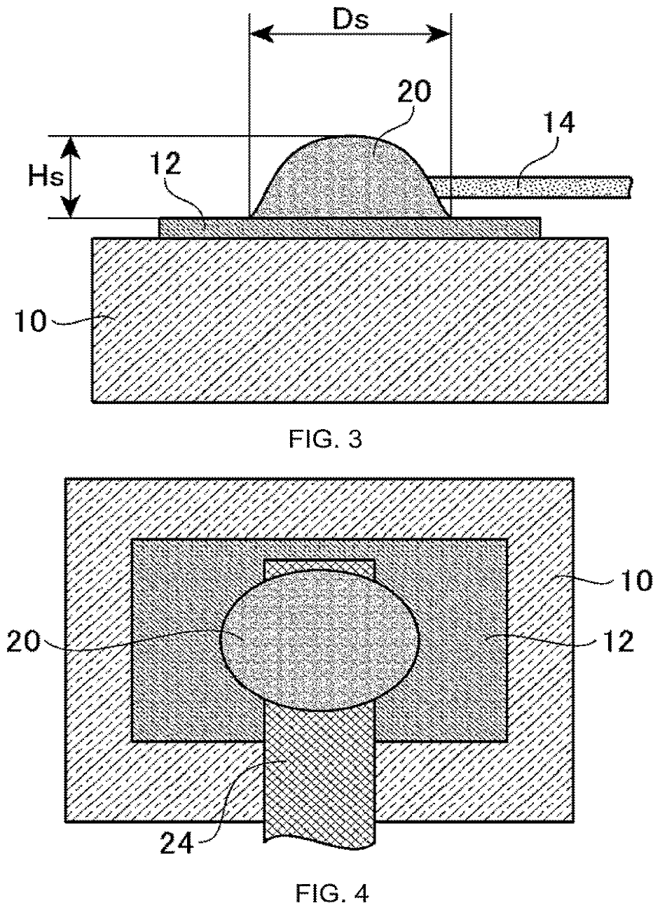

Before a soldering step, the wire connector 14 may be positioned over the glass substrate 10 in an area for attaching the wire connector 14, particularly at a connecting surface 12. In some embodiments, the wire connector 14 may be held in place over the connecting surface 12 by an adhesive, which may include, for example, a double sided tape. The adhesive may be in an area separate from the wire end 16 and the connecting surface 12 and may be temporary. A nozzle 18 of an extruder may manually or automatically approach the area for attaching the wire connector 14 at the connecting surface 12. A wire connector 14 may be cut from the reel with an appropriate length for the intended connection. In some other embodiments, the wire connector 14 may be pre-cut. The connecting surface 12 and the wire connector 14 may be provided in an area around a periphery of the glazing such that the connecting surface 12 and the wire connector 14 may be aligned with a black print around the glazing. The black print may hide the connector from view of a vehicle exterior when the glazing is installed in a vehicle. After the nozzle 18 of the extruder faces the position of the wire end 16, the soldering material 20 may be extruded over the wire end 16, such that the soldering material 20 is in contact with the connecting surface 12 and the wire connector 14, as shown in FIGS. 2 and 3. FIG. 2 shows a step of the soldering process at which the soldering material 20 supplied from the nozzle 18 is still melting or transiting from the melting state or solid state as it is extruded. FIG. 3 shows the soldered wire connector 14 on the glass substrate 10 after the soldering process. The soldering material 20 is formed in a mound shape and covers the wire end 16. In a typical example, the diameter Ds of the mound-shaped soldering material 20 may be in a range of 1 mm to 20 mm, preferably 5 mm to 15 mm. The height Hs of the mound-shaped soldering material 20 may be in a range of 0.5 mm to 5 mm, preferably 1 mm to 3 mm.

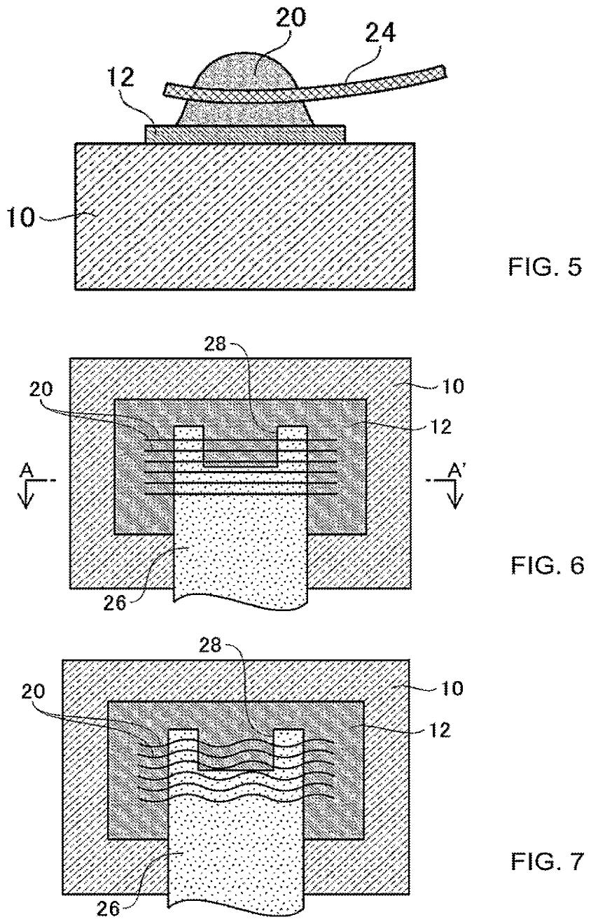

FIGS. 4 and 5 show a soldered structure in use with a mesh connector 24. In this embodiment, the mesh connector 24 may be made of woven metal fine wires. The metal fine wires may be made of copper, aluminum, nickel, silver or any other suitable metals or alloys. The mesh 24 or mesh wires may also be coated with a suitable plating material(s), such as silver, nickel, or tin, which may improve bonding to the solder alloy. The mesh connector 24 may include many spaces between the woven metal fine wires, so that the soldering material 20 may flow around the spaces when extruded over the mesh connector 24, and so that the solidified soldering material 20 may securely fasten the mesh connector 24 to the connecting surface 12. The soldering material 20 may reach the connecting surface 12 through the spaces of the mesh connector 24, thereby attaching the mesh connector 24 to the connecting surface 12. A mesh connector 24 may be cut from the reel with an appropriate length for the intended connection. In some other embodiments, the mesh connector 24 may be pre-cut.

The mesh may have a thickness in a range 0.1 mm to 3.0 mm, preferably 0.2 mm to 2.0 mm. The mesh connector 24 may also have a width in a range of 1.0 mm to 50 mm, preferably 5 mm to 30 mm, and more preferably 10 mm to 20 mm. The metal fine wires may have a diameter in a range of 10 micrometers to 500 micrometers, preferably 50 micrometers to 300 micrometers, and more preferably 100 micrometers to 200 micrometers.

Releasing the solder 20 over the connector 14, 24 may provide solder material 20 over the connector 24 and connecting surface 12. The solder material 20 may preferably be provided in a quantity such that the solder material 20 may bond to the connector 24 and the connecting surface 12. The amount of material 20 released may be automated in an extruder such that a repeatable process is possible. In some embodiments, it may be desirable to provide the solder material 20 in a pattern over the connector 14, 24, 26. Such a pattern may include, for example, lines across a connector 26 and connecting surface 12, as shown in FIGS. 6 to 9. Some further patterns may include multiple spots, or mounds, of soldering material 20. The pattern may be provided in a single layer or multiple layers of solder material 20. Where a pattern includes multiple layers, the layers may have the same or different designs.

In some embodiments, the glass substrate 10 may be heated during the metal extrusion process. Applying a hot solder material 20 to a cold glass substrate 10 may induce cracks in the glass substrate 10 which are undesirable. Heating the glass substrate 10 may allow for the soldering material 20 and the glass substrate 10 to cool together. The soldering material 20 may be chosen to provide a suitable thermal expansion such that the soldering material 20 condenses at a rate similar to the glass substrate 10 material. The glass substrate 10 material may include a soda-lime glass. The glass substrate 10 may include clear, green, or privacy glass. Heating the glass 10 may further induce a stronger chemical bond with the soldering material 20. For some soldering material 20, heating of the glass substrate 10 may not be necessary to create a suitable chemical bond without inducing cracks.

The extrusion of soldering material 20 may be performed by an extruder which heats and distributes the soldering material 20. The soldering material 20 may preferably be fed into the extruder as a metal filament. In some embodiments, an extruder may provide for a basin of soldering material 20 where the soldering material 20 may be provided in any suitable form, including filaments or larger pieces. The extruder may heat the solder filament and dispense the soldering material 20 from a nozzle. The extruder may heat the soldering material 20 to at least a melting temperature of the solder 20. The extruder nozzle 18 may move over a connecting surface 12 to release soldering material 20 or the extruder nozzle 18 may remain stationary and glass substrate 10 having a connecting surface 12 may be moved in relation to the nozzle 18. The nozzle 18 may release the soldering material 20 to provide a designed pattern or release an amount of solder 20 over a connection area without a pattern. The amount of solder 20 to be released may be programmed such that the extruder may release a consistent amount of solder 20. Where the solder 20 is over the connecting surface 12, the solder 20 may be positioned over the connecting surface 12 and connector 14, 24, 26, forming a mechanical and electrical connection between the connecting surface 12 and the connector 14, 24, 26. A soldering material 20 pattern may have a line thickness of 0.5 mm or more according to the size of the nozzle 18 and speed of the operation, including a moving speed of the extruding head.

In some embodiments, an extruded pattern may be determined to connect a connector to the glass substrate 10, as shown in FIGS. 6 to 8. A system of the tool may control the amount and location of administering the soldering material 20, such that an even and accurate application of material 20 may be consistently performed. The tool may be positioned close enough to a glass substrate 10 such that the soldering material 20 has not hardened when the soldering material 20 reaches the glass substrate 10 at the connecting surface 12. In some embodiments, the connector 14, 24, 26 may be in the form of a wire or a foil or mesh which may be positioned above the glass substrate 10 while soldering material 20 is administered onto the connector 14, 24, 26 and the connecting surface 12.

FIG. 6 shows an example of a foil connector 26. The foil connector 26 may be made of copper, aluminum, nickel, silver or any other suitable metals or alloys. A foil connector 26 may also be coated with a suitable plating material, such as silver or tin, which may improve bonding to the solder alloy. An end of the foil connector 26 may be formed with a recess 28 at a center of the foil end. The soldering material 20 is provided in a pattern of multiple parallel lines extending over the connecting surface 12 and the foil connector 26, and particularly some lines crossing the recess 28. In this embodiment, the foil connector 26 may have a width of 1 mm or more. The recess 28 may extend the edge length of the foil end, thereby increasing adhering force of the soldering material 20 to the connecting surface 12 and the foil connector 26. FIG. 9 shows the A-A′ cross section of the solder jointing structure shown in FIG. 6. In some embodiments, the solder material 20 may flow partially under the foil connector 26. A foil connector 26 may be cut from the reel with an appropriate length for the intended connection. In some other embodiments, the foil connector 26 may be pre-cut.

The foil connector may have a thickness in a range of 1 micrometer to 200 micrometers, preferably 10 micrometers to 100 micrometers, and more preferably 30 micrometers to 80 micrometers. The foil may have a width in a range of 1.0 mm to 50 mm, preferably 5 mm to 30 mm, and more preferably 10 mm to 20 mm.

FIG. 7 shows another pattern of multiple wave lines of soldering material 20. The soldering material 20 may extend in a wave fashion extending over the connecting surface 12 and the foil connector 26, and particularly some lines crossing the recess 28. This wave pattern may provide more contact surface area between the soldering material 20 and the connecting surface 12 and the foil connector 26. Such a wave pattern may be easily formed by periodical move of the nozzle 18 of the extruder.

Although the patterns shown in FIGS. 6 and 7 can be produced by a relatively simple movement of the extruder, other patterns such as random, crossing, circling, or hybrid patterns may be used for attaching the connector 14, 24, 26.

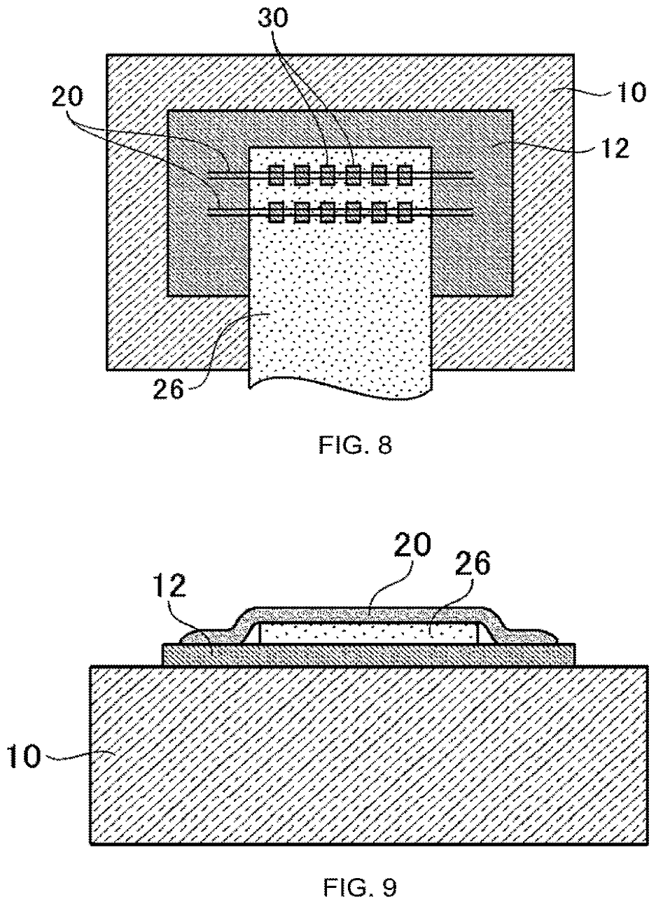

FIG. 8 shows another foil connector 26. The foil connector 26 has an end with multiple openings 30. In this embodiment, the openings 30 are arranged in a matrix form of two rows. Where the opening 30 is formed, the connecting surface 12 is exposed. The soldering material 20 may be provided with a pattern of multiple parallel lines as to cross each row of the openings 30. From this pattern of the soldering material 20, the foil connector 26 may be securely fastened to the connecting surface 12.

Where the openings 30 are formed in the foil connector 26, the opening 30 may have a width in a range of 0.5 mm to 3 mm, preferably 1.0 mm to 2.5 mm. The openings 30 may constitute a percentage of the connector 26 overlapping with the connecting surface 12 in a range from 20% to 70%, preferably from 40% to 60%.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A method of attaching a connector to a glass substrate, the method comprising:
positioning a connector over a glass substrate at a connecting surface for attaching the connector; and
extruding a soldering material over the connector.

2. (canceled)

3. (canceled)

4. (canceled)

5. The method according to claim 1, wherein the soldering material comprises at least one of indium, tin, silver, and alloys thereof.

6. (canceled)

7. (canceled)

8. The method according to claim 1, wherein the connector is cut from a reel.

9. The method according to claim 1, wherein the connector includes a wire.

10. The method according to claim 9, wherein the wire includes a frayed wire end.

11. The method according to claim 1, wherein the connector includes a mesh.

12. The method according to claim 1, wherein the connector includes a foil.

13. The method according to claim 1, wherein extruding the soldering material includes extruding the soldering material in a pattern.

14. The method according to claim 13, wherein the pattern includes more than one layer.

15. (canceled)

16. The method according to claim 1, wherein the soldering material is extruded from an extruder with a nozzle having a diameter of 0.5 mm or more.

17. The method according to claim 1 wherein the glass substrate is heated while the soldering material is extruded.

18. The method according to claim 1, wherein the connector is adhered to the glass substrate in position at the connector surface prior to extruding the soldering material.

19. (canceled)

20. (canceled)

21. A soldered connector structure, comprising:
a glass substrate;
a connecting surface formed on the glass substrate;
a soldering material formed by extrusion on the connecting surface; and
a connector electrically coupled to the connecting surface via the soldering material.

22. The soldered connector structure according to claim 21, wherein the soldering material comprises at least one of indium based solder and tin-silver based solder.

23. (canceled)

24. The soldered connector structure according to claim 21, wherein the connector includes a wire.

25. The soldered connector structure according to claim 24, wherein the wire includes a frayed end.

26. (canceled)

27. The soldered connector structure according to claim 21, wherein the soldering material is formed in a mound shape embedding an end of the wire and having a height of 0.5 mm or more.

28. The soldered connector structure according to claim 21, wherein the connector includes a mesh.

29. (canceled)

30. The soldered connector structure according to claim 28, wherein the soldering material is formed in a mound shape embedding the mesh and having a height of 0.5 mm or more.

31. The soldered connector structure according to claim 21, wherein the connector includes a foil.

32. (canceled)

33. (canceled)

34. (canceled)

35. (canceled)
